(19) United States
(12) Patent Application Publication
(10) Pub. No.: US 2026/0189489 A1
(43) Pub. Date: Jul. 2, 2026

(54) MONITORING DEVICE, VEHICLE MONITORING METHOD, AND VEHICLE MONITORING PROGRAM

(71) Applicants: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(72) Inventor: Shinichi AIBA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(21) Appl. No.: 18/862,696

(22) PCT Filed: Apr. 6, 2023
(86) PCT No.: PCT/JP2023/014203

§ 371 Date: Nov. 4, 2024

(30) Foreign Application Priority Data
May 12, 2022 (JP) 2022-078888

(51) Int. Cl. H04L 43/0823; B60R 16/023; G06F 11/10

(52) U.S. Cl. CPC H04L 43/0823; B60R 16/0231; G06F 11/1004

(57) ABSTRACT

A monitoring device to be installed in a vehicle includes a monitoring unit configured to monitor a count value of a counter that counts the number of occurrences of an error detected in an in-vehicle network of the vehicle, a pattern information generation unit configured to generate pattern information indicating temporal change in the count value, based on a result of the monitoring by the monitoring unit, and an abnormality detection unit configured to detect an abnormality in the in-vehicle network, based on the pattern information generated by the pattern information generation unit and reference information that is based on temporal change in the count value measured in advance.

### CROSS-REFERENCE TO RELATED APPLICATIONS

This application is the U.S. national stage of PCT/JP2023/014203 filed on Apr. 6, 2023, which claims priority of Japanese Patent Application No. JP 2022-078888 filed on May 12, 2022, the contents of which are incorporated herein.

### TECHNICAL FIELD

The present disclosure relates to a monitoring device, a vehicle monitoring method, and a vehicle monitoring program.

### BACKGROUND ART

Heretofore, technologies for improving security in in-vehicle networks have been developed.

JP 2013-131907A discloses the following technology. That is, a vehicle network monitoring device for monitoring communication data in a vehicle network in which data is communicated between a plurality of in-vehicle control devices, including a monitoring unit that detects unauthorized data by monitoring a data communication form defined for applying a communication protocol used in the vehicle network. The monitoring unit monitors the number of transmissions of an error frame by the in-vehicle control devices based on detection of errors as the data communication form, and detects that unauthorized data is being transmitted to the vehicle network when the monitored number of transmissions of the error frame exceeds a defined number of transmissions.

There is demand for a technology that surpasses the technology described in JP 2013-131907A and enables more accurate determination with regard to abnormalities in a vehicle.

The present disclosure was made to solve the above issue, and an object of the present disclosure is to provide a monitoring device, a vehicle monitoring method, and a vehicle monitoring program that enable abnormalities in a vehicle to be more accurately determined.

### SUMMARY

A monitoring device according to the present disclosure is a monitoring device to be installed in a vehicle, including a monitoring unit configured to monitor a count value of a counter that counts the number of occurrences of an error detected in an in-vehicle network of the vehicle, a pattern information generation unit configured to generate pattern information indicating temporal change in the count value, based on a result of the monitoring by the monitoring unit, and an abnormality detection unit configured to detect an abnormality in the in-vehicle network, based on the pattern information generated by the pattern information generation unit and reference information that is based on temporal change in the count value measured in advance.

A vehicle monitoring method according to the present disclosure is a vehicle monitoring method in a monitoring device to be installed in a vehicle, the vehicle monitoring method including a step of monitoring a count value of a counter that counts the number of occurrences of an error detected in an in-vehicle network of the vehicle, a step of generating pattern information indicating temporal change in the count value, based on a result of the monitoring, and a step of detecting an abnormality in the in-vehicle network, based on the generated pattern information and reference information that is based on temporal change in the count value measured in advance.

A vehicle monitoring program according to the present disclosure is a vehicle monitoring program for use in a monitoring device to be installed in a vehicle, the program causing a computer to function as a monitoring unit configured to monitor a count value of a counter that counts the number of occurrences of an error detected in an in-vehicle network of the vehicle, a pattern information generation unit configured to generate pattern information indicating temporal change in the count value, based on a result of the monitoring by the monitoring unit, and an abnormality detection unit configured to detect an abnormality in the in-vehicle network, based on the pattern information generated by the pattern information generation unit and reference information that is based on temporal change in the count value measured in advance.

One mode of the present disclosure can be realized as a semiconductor integrated circuit that realizes part or all of a monitoring device, or as a system that includes the monitoring device.

### Advantageous Effects of Invention

According to the present disclosure, abnormalities in a vehicle can be more accurately determined.

### BRIEF DESCRIPTION OF DRAWINGS

FIG. 1 is a diagram showing a configuration of a vehicle monitoring system according to an embodiment of the present disclosure.

FIG. 2 is a diagram showing a configuration of an in-vehicle communication system according to the embodiment of the present disclosure.

FIG. 3 is a diagram showing a configuration of a gateway device in the in-vehicle communication system according to the embodiment of the present disclosure.

FIG. 4 is a diagram showing an example of transition of a count value of an error counter and abnormality detection timing in the in-vehicle communication system according to the embodiment of the present disclosure.

FIG. 5 is a flowchart of an example of an operation procedure when an abnormality in an in-vehicle network is detected by the gateway device according to the embodiment of the present disclosure.

FIG. 6 is a flowchart of an example of an operation procedure when stop control is performed by the gateway device according to the embodiment of the present disclosure.

### DETAILED DESCRIPTION OF PREFERRED EMBODIMENTS

First, the contents of embodiments of the present disclosure will be listed and described.

In a first aspect, a monitoring device according to an embodiment of the present disclosure is a monitoring device to be installed in a vehicle, including a monitoring unit configured to monitor a count value of a counter that counts the number of occurrences of an error detected in an in-vehicle network of the vehicle, a pattern information generation unit configured to generate pattern information indicating temporal change in the count value, based on a result of the monitoring by the monitoring unit, and an abnormality detection unit configured to detect an abnormality in the in-vehicle network, based on the pattern information generated by the pattern information generation unit and reference information that is based on temporal change in the count value measured in advance.

In a vehicle, even during normal operation, errors may occur due to factors such as electromagnetic waves generated by the various devices and wire harness. Thus, with a method that determines an abnormality when the number of error occurrences exceeds a predetermined threshold value, misdetection of abnormalities may occur. In contrast, by using a configuration that performs abnormality detection using temporal change in the count value of error occurrences, such as described above, misdetection due to a natural increase in the number of error occurrences can be prevented, and abnormalities in the vehicle can be determined more accurately.

In a second aspect according to the first aspect, the reference information may be pattern information indicating temporal change in the count value measured in advance, and the abnormality detection unit may compare the pattern information generated by the pattern information generation unit with the reference information and detect an abnormality in the in-vehicle network, based on a result of the comparison.

With this configuration, it is possible to detect an abnormality in the vehicle by simple processing for comparing the two pieces of pattern information.

In a third aspect according to the second aspect, the abnormality detection unit may be capable of performing first abnormality detection processing for detecting the abnormality based on the pattern information generated by the pattern information generation unit and the reference information, and second abnormality detection processing for detecting the abnormality based on a result of comparison between the count value and a predetermined threshold value, and a maximum value of the count value in the reference information may be smaller than the predetermined threshold value.

With this configuration, it is possible to detect an abnormality from the increasing trend of the count value without waiting until the count value reaches the predetermined threshold value. That is, it is possible to detect an abnormality before the count value reaches the predetermined threshold value, thereby shortening the time during which the in-vehicle network is vulnerable to attacks and suppressing the influence of cyberattacks and the like on the vehicle.

In a fourth aspect according to any of the first through the third aspects, the abnormality detection unit may perform the first abnormality detection processing for detecting the abnormality based on the pattern information generated by the pattern information generation unit and the reference information in parallel with the second abnormality detection processing for detecting the abnormality based on the result of comparison between the count value and the predetermined threshold value.

With this configuration, it is possible to perform more versatile abnormality detection by the method using the threshold value and the method using the pattern information.

In a fifth aspect according to any one of the first through the fourth aspects, the error may be an error relating to communication in the in-vehicle network.

With this configuration, it is possible to more accurately detect abnormalities caused by cyberattacks and the like on the vehicle.

In a sixth aspect according the to fifth aspect, the error may be an error caused by a cyclic redundancy check (CRC) conforming to controller area network (CAN) standards.

This configuration makes it easy to perform abnormality detection by utilizing an existing mechanism that conforms to bus standards widely used in vehicles.

In a seventh aspect according to the second aspect, the abnormality detection unit may detect the abnormality by performing the comparison using a statistical analysis technique.

With this configuration, it is possible to compare the two pieces of pattern information more accurately using statistical processing.

In an eighth aspect according to the first aspect, the reference information may be a learning model created by machine learning using temporal change in the count value measured in advance, and the abnormality detection unit may detect an abnormality in the in-vehicle network by providing the pattern information generated by the pattern information generation unit to the learning model.

With this configuration, it is possible to compare the two pieces of pattern information more accurately using machine learning.

In a ninth aspect according to any one of the first through the eighth aspects, the monitoring device may further include an abnormality processing unit configured to perform predetermined notification processing when the abnormality detection unit detects the abnormality.

With this configuration, it is possible to analyze the abnormality in an external device capable of grasping a wider range of information, and to prevent the user from continuing to use the vehicle while he/she is unaware of unauthorized access to the vehicle, data tampering and the like or is unaware of minor malfunctions of the vehicle.

In a tenth aspect according to any of the first through the ninth aspects, an abnormality processing unit may be provided to perform control for stopping the monitoring device from receiving data from the in-vehicle network when the abnormality detection unit detects the abnormality.

With this configuration, when the monitoring device is provided in a gateway device or the like in the in-vehicle network, for example, the influence of cyberattacks and the like on the vehicle can be suppressed.

In an eleventh aspect according to the tenth aspect, the abnormality processing unit cancels the stop control after a predetermined time elapses from when the stop control is performed.

With this configuration, it is possible to continue communication in the in-vehicle network while suppressing the influence of cyberattacks and the like on the vehicle, for example.

In a twelfth aspect according to the eleventh aspect, the reference information is pattern information indicating temporal change in the count value measured in advance, the abnormality detection unit compares the pattern information generated by the pattern information generation unit with the reference information and detects an abnormality in the in-vehicle network, based on a result of the comparison, and the abnormality processing unit sets the predetermined time according to the result of the comparison.

With this configuration, it is possible to set the period for which data reception is stopped to an appropriate length, according to the degree of mismatch between the two pieces of pattern information.

In a thirteenth aspect, a vehicle monitoring method according to an embodiment of the present disclosure is a vehicle monitoring method in a monitoring device to be installed in a vehicle, the vehicle monitoring method including a step of monitoring a count value of a counter that counts the number of occurrences of an error detected in an in-vehicle network of the vehicle, a step of generating pattern information indicating temporal change in the count value, based on a result of the monitoring, and a step of detecting an abnormality in the in-vehicle network, based on the generated pattern information and reference information that is based on temporal change in the count value measured in advance.

In a vehicle, even during normal operation, errors may occur due to factors such as electromagnetic waves generated by the various devices and wire harness. Thus, with a method that determines an abnormality when the number of error occurrences exceeds a predetermined threshold value, misdetection of abnormalities may occur. In contrast, by using a configuration that performs abnormality detection using temporal change in the count value of error occurrences, such as described above, misdetection due to a natural increase in the number of error occurrences can be prevented, and abnormalities in the vehicle can be determined more accurately.

In a fourteenth aspect, a vehicle monitoring program according to an embodiment of the present disclosure is a vehicle monitoring program for use in a monitoring device to be installed in a vehicle, the program causing a computer to function as a monitoring unit configured to monitor a count value of a counter that counts the number of occurrences of an error detected in an in-vehicle network of the vehicle, a pattern information generation unit configured to generate pattern information indicating temporal change in the count value, based on a result of the monitoring by the monitoring unit, and an abnormality detection unit configured to detect an abnormality in the in-vehicle network, based on the pattern information generated by the pattern information generation unit and reference information that is based on temporal change in the count value measured in advance.

In a vehicle, even during normal operation, errors may occur due to factors such as electromagnetic waves generated by the various devices and wire harness. Thus, with a method that determines an abnormality when the number of error occurrences exceeds a predetermined threshold value, misdetection of abnormalities may occur. In contrast, by using a configuration that performs abnormality detection using temporal change in the count value of error occurrences, such as described above, misdetection due to a natural increase in the number of error occurrences can be prevented, and abnormalities in the vehicle can be determined more accurately.

Embodiments of the present disclosure will be described below with reference to the drawings. In the drawings, the same or corresponding portions are given the same reference numerals, and description thereof will not be repeated. Also, at least some of the embodiments described below may be combined as desired.

### Configuration and Operations

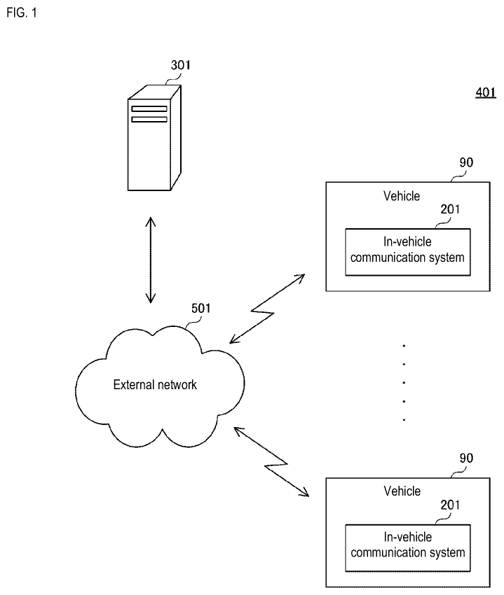

FIG. 1 is a diagram showing a configuration of a vehicle monitoring system according to an embodiment of the present disclosure. Referring to FIG. 1, a vehicle monitoring system 401 includes one or more in-vehicle communication systems 201 and a management server 301 that is an example of an external device. The in-vehicle communication system 201 is installed in a vehicle 90.

The in-vehicle communication system 201 monitors the error occurrence situation in the in-vehicle network of the vehicle 90 and detects an abnormality in the in-vehicle network of the vehicle 90 based on a result of the monitoring. When an abnormality is detected, the in-vehicle communication system 201 transmits abnormality occurrence information generated based on the occurrence situation to the management server 301 via an external network 501.

The management server 301 receives the abnormality occurrence information transmitted from the in-vehicle communication system 201, analyzes the abnormality occurrence information and, based on the analysis result, performs processing for notifying the user that unauthorized access to the vehicle 90, data tampering, and the like have occurred.

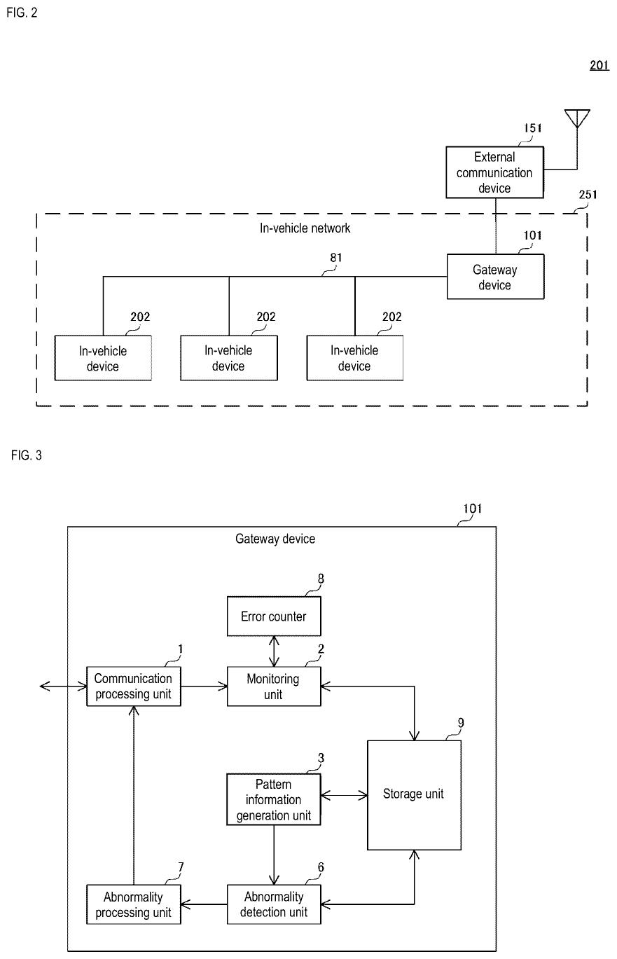

FIG. 2 is a diagram showing a configuration of an in-vehicle communication system according to the embodiment of the present disclosure. Referring to FIG. 2, the in-vehicle communication system 201 includes a gateway device 101 that is an example of a monitoring device, one or more in-vehicle devices 202, and an external communication device 151. For example, an in-vehicle network 251 is constituted by the gateway device 101 and the one or more in-vehicle devices 202. FIG. 2 shows an example in which the in-vehicle network 251 includes one gateway device 101 and three in-vehicle devices 202.

The gateway device 101 is connected to the in-vehicle devices via a bus 81, for example. Specifically, the bus 81 is a bus that conforms to standards such as Controller Area Network (CAN) (registered trademark), CAN with Flexible Data Rate (CAN FD), CAN XL, FlexRay (registered trademark), Media Oriented Systems Transport (MOST) (registered trademark), Ethernet (registered trademark), and Local Interconnect Network (LIN), for example.

The in-vehicle device 202 is a sensor, an actuator, a camera, a global positioning system (GPS) receiver, a navigation device, an automated driving processing electronic control unit (ECU), an Advanced Driving Assistant System (ADAS) ECU, a wiper control device, an engine control device, an automatic transmission (AT) control device, an hybrid electric vehicle (HEV) control device, a brake control device, a chassis control device, a steering control device, an instrument display control device, a maintenance device, or the like.

The gateway device 101 is connected to the plurality of in-vehicle devices 202 and the external communication device 151 and can communicate with each of the in-vehicle devices 202 and the external communication device 151. Instead of the gateway device 101, an integrated ECU that controls the operations of the in-vehicle devices 202 may be provided as an example of a monitoring device in the in-vehicle network 251, for example.

Each in-vehicle device 202 regularly or irregularly stores vehicle-related information indicating measurement results relating to the vehicle 90 and an ID of the in-vehicle device 202 in a frame and transmits the frame to other in-vehicle devices 202 connected to the bus 81, for example. The in-vehicle device 202 may be configured to transmit the frame to the gateway device 101 or to transmit the frame to the gateway device 101 and other in-vehicle devices (not shown) via a cable or a bus (not shown).

FIG. 3 is a diagram showing a configuration of the gateway device in the in-vehicle communication system according to the embodiment of the present disclosure. Referring to FIG. 3, the gateway device 101 includes a communication processing unit 1, a monitoring unit 2, a pattern information generation unit 3, an abnormality detection unit 6, an abnormality processing unit 7, an error counter 8, and a storage unit 9. The storage unit 9 is a non-volatile memory, for example.

When frames are directly transmitted and received between the in-vehicle devices 202 via the bus 81, the communication processing unit 1 receives in parallel frames transmitted from the in-vehicle devices 202 to other in-vehicle devices 202 via the bus 81. The communication processing unit 1 may be configured to receive a frame to be transmitted between an in-vehicle device 202 and an in-vehicle device such as the external communication device 151 in order to perform relay processing for relaying the frame.

The monitoring unit 2 monitors a count value CN of the error counter 8 that counts the number of occurrences of an error, that is, a mistake or a failure, detected in the in-vehicle network 251 of the vehicle 90.

For example, the error is an error relating to communication in the in-vehicle network 251. Specifically, the error is an error caused by a cyclic redundancy check (CRC) conforming to CAN standards, for example.

More specifically, upon receipt of a frame from an in-vehicle device 202 via the bus 81, the communication processing unit 1 performs processing for detecting an error relating to the received frame. When the error is detected, the communication processing unit 1 outputs an error occurrence notification indicating the reception time of the frame to the monitoring unit 2.

Upon receipt of the error occurrence notification from the communication processing unit 1, the monitoring unit 2 increments the error counter 8. The monitoring unit 2 saves a set of the count value CN of the error counter 8 after incrementation and the reception time indicated by the error occurrence notification to the storage unit 9. Accordingly, a log of the error occurrence situation in the in-vehicle network 251 is collected and saved to the storage unit 9. The present disclosure is not limited to the configuration in which the monitoring unit 2 increments the error counter 8 and may be applied to a configuration in which a unit other than the monitoring unit 2 increments the error counter 8.

The pattern information generation unit 3 generates pattern information that is time-series data indicating temporal change in the count value CN (hereinafter, also called error log information), based on a result of the monitoring by the monitoring unit 2, and outputs the generated pattern information to the abnormality detection unit 6. More specifically, the pattern information generation unit 3 generates the error log information based on the log saved to the storage unit 9. The error log information indicates the error occurrence situation, for example, an increasing trend of the count value CN. The error log information is time-series data for a period of 1 second or 10 seconds, for example.

The abnormality detection unit 6 detects an abnormality in the in-vehicle network 251 based on the error log information generated by the pattern information generation unit 3 and reference information that is based on temporal change in the count value CN measured in advance. When the abnormality is detected, the abnormality detection unit 6 notifies the occurrence of the abnormality to the abnormality processing unit 7, and outputs error log information corresponding to the abnormality to the abnormality processing unit 7.

More specifically, the reference information is pattern information indicating temporal change in the count value CN measured in advance. The abnormality detection unit 6 compares the error log information received from the pattern information generation unit 3 with the reference information saved to the storage unit 9 and detects an abnormality in the in-vehicle network 251 based on a result of the comparison.

As an example, the reference information is created based on the count value CN of the error counter 8 collected from test driving or the like before shipment of the vehicle 90.

In the vehicle 90, even during normal operation, errors may occur due to factors such as electromagnetic waves generated by the various devices and wire harness. Thus, it is possible to obtain pattern information indicating some sort of error occurrence situation, as reference information.

For example, the abnormality detection unit 6 detects an abnormality by performing the above comparison using a statistical analysis method. Specifically, the statistical analysis is variance analysis or linear regression analysis, for example.

The reference information may be a learning model that is created by machine learning using temporal change in the count value CN measured in advance. That is, the abnormality detection unit 6 may be configured to detect an abnormality in the in-vehicle network 251 by providing the pattern information generated by the pattern information generation unit 3 to the learning model.

Specifically, the abnormality detection unit 6 uses a learning model based on a deep learning technique as an example of machine learning.

When the abnormality detection unit 6 detects an abnormality, the abnormality processing unit 7 performs predetermined notification processing. More specifically, upon receipt of a notification from the abnormality detection unit 6, the abnormality processing unit 7 outputs abnormality occurrence information indicating the error log information received from the abnormality detection unit 6 to the communication processing unit 1, for example.

The abnormality processing unit 7 may be configured to regularly or irregularly output information indicating normal operation to the communication processing unit 1 when an abnormality is not detected.

The communication processing unit 1 outputs the abnormality occurrence information received from the abnormality processing unit 7 to the external communication device 151.

The external communication device 151 communicates with the management server 301 via the external network 501 shown in FIG. 1 by performing wireless communication with a wireless base station (not shown), in accordance with a communication scheme such as WiFi (registered trademark) or Long Term Evolution (LTE) (registered trademark).

For example, the external communication device 151 receives abnormality occurrence information from the communication processing unit 1 in the gateway device 101 and transmits the abnormality occurrence information to the management server 301 via the external network 501.

The management server 301 receives the abnormality occurrence information transmitted from the external communication device 151 via the external network 501 and analyzes the abnormality occurrence information. Then, the management server 301 transmits analysis information indicating the analysis result to a user terminal (not shown) or the vehicle 90 via the external network 501, for example.

As another example of the notification processing, the abnormality processing unit 7 may be configured to transmit the abnormality occurrence information to an in-vehicle device 202 serving as a navigation device via the communication processing unit 1 and notify the user of the contents of the abnormality occurrence information using the navigation device. The abnormality processing unit 7 may also be configured to transmit the abnormality occurrence information to a specific in-vehicle device 202 via the communication processing unit 1, or to broadcast the abnormality occurrence information.

Also, the abnormality processing unit 7 may be configured to perform stop control for stopping the gateway device 101 from receiving data from the in-vehicle network 251 when the abnormality detection unit 6 detects an abnormality.

More specifically, as an example of the stop control, the abnormality processing unit 7 performs bus shutdown, that is, controls the communication processing unit 1 to discard all frames arriving at the communication processing unit 1 from the bus 81. For example, after a predetermined time elapses from when the bus shutdown is performed, the abnormality processing unit 7 cancels the bus shutdown and returns to the normal state.

The abnormality processing unit 7 may be configured to set the above-described predetermined time (hereinafter, also referred to as recovery time) according to the result of comparison between the error log information and the reference information by the abnormality detection unit 6. Specifically, for example, when it is determined that the error log information and the reference information do not match, the abnormality detection unit 6 notifies the occurrence of an abnormality and the degree of mismatch between the error log information and the reference information to the abnormality processing unit 7. For example, the abnormality processing unit 7 sets the recovery time to a large value when the degree of mismatch is large and sets the recovery time to a small value when the degree of mismatch is small. The degree of mismatch is indicated by a score obtained by the various analysis described above, or by the number of mismatches in the pattern comparison, for example.

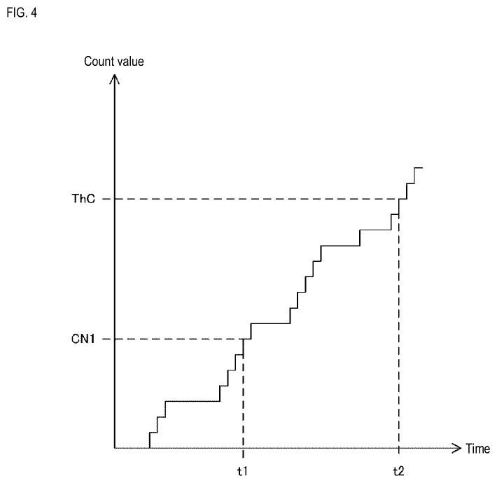

FIG. 4 is a diagram illustrating an example of transition of the count value of the error counter and abnormality detection timing in the in-vehicle communication system according to the embodiment of the present disclosure. In FIG. 4, the horizontal axis indicates time and the vertical axis indicates the count value CN.

Referring to FIG. 4, in a comparative example in which abnormality detection processing is performed based on the result of comparison between the count value CN and a predetermined threshold value ThC, the count value CN becomes equal to or greater than the threshold value ThC at time t2, and an abnormality in the in-vehicle network 251 is detected.

In contrast, the gateway device 101, by being configured to detect an abnormality based on error log information indicating temporal change in the count value CN and reference information that is based on temporal change in the count value CN measured in advance, is able to detect an abnormality from the increasing trend of the count value CN without waiting until the count value CN reaches a predetermined threshold value. That is, as shown in FIG. 4, for example, an abnormality can be detected at time t1 earlier than time t2 at which the count value CN reaches the threshold value ThC. For example, when the abnormality processing unit 7 performs the bus shutdown as described above, it is possible to shorten the time during which the in-vehicle network 251 is subjected to denial-of-service (DOS) attacks and the like compared to the comparative example, and it is thus possible to make it more difficult to attach unauthorized devices to the in-vehicle network 251.

### Modifications

The abnormality detection unit 6 may be capable of performing first abnormality detection processing for detecting an abnormality based on pattern information generated by the pattern information generation unit 3 and reference information, and second abnormality detection processing for detecting an abnormality based on the result of comparison between the count value CN and the predetermined threshold value ThC.

That is, the abnormality detection unit 6 may be capable of selectively performing either the first abnormality detection processing or the second abnormality detection processing.

The maximum value of the count value CN in the reference information is smaller than the predetermined threshold value ThC. For example, in the example shown in FIG. 4, the maximum value is CN1.

The abnormality detection unit 6 may be configured to perform the first abnormality detection processing in parallel with the second abnormality detection processing.

### Flow of Operations

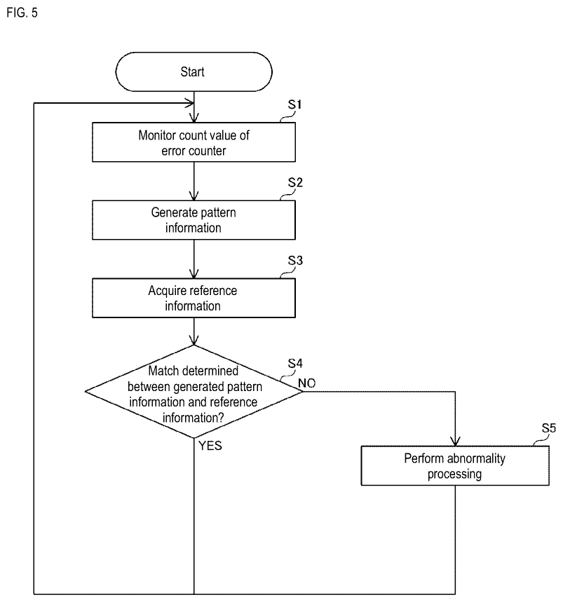

FIG. 5 is a flowchart of an example of an operation procedure when the gateway device according to the embodiment of the present disclosure detects an abnormality in the in-vehicle network.

Referring to FIG. 5, first, the gateway device 101 monitors the count value CN of the error counter 8 in the in-vehicle network 251, collects a log of the error occurrence situation in the in-vehicle network 251, and saves the log to the storage unit 9 (step S1).

Then, the gateway device 101 generates pattern information, that is, error log information, which is time-series data indicating temporal change in the count value CN, based on the result of the monitoring, such as based on the log saved to the storage unit 9, for example (step S2).

Then, the gateway device 101 acquires the reference information saved to the storage unit 9, such as the pattern information indicating temporal change in the count value CN of the error counter 8 measured in advance, for example, from the storage unit 9 (step S3).

Then, the gateway device 101 compares the generated error log information with the reference information, and, if it is determined that the two pieces of information do not match (NO in step S4), performs the above-described abnormality processing (step S5).

If it is determined that the generated error log information matches the reference information (YES in step S4), or after performing the abnormality processing (step S5), the gateway device 101 continues monitoring the count value CN and collecting the log (step S1).

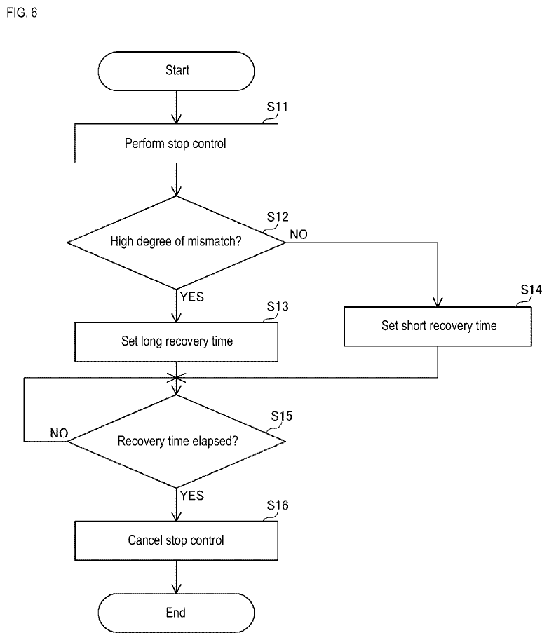

FIG. 6 is a flowchart of an example of an operation procedure when the gateway device according to the embodiment of the present disclosure performs stop control.

Referring to FIG. 6, first, when an abnormality in the in-vehicle network 251 is detected as described above, the gateway device 101 performs stop control for stopping the gateway device 101 from receiving data from the in-vehicle network 251 (step S11).

Then, if the degree of mismatch between the error log information and the reference information is large (YES in step S12), the gateway device 101 sets the recovery time to TL (step S13), and if the degree of mismatch is small (NO in step S12), the gateway device 101 sets the recovery time to TS, which is shorter than TL (step S14).

Then, when the recovery time elapses from when the stop control is started (YES in step S15), the gateway device 101 cancels the stop control and returns to the normal state (step S16).

In the in-vehicle communication system according to the embodiment of the present disclosure, the gateway device 101 includes the error counter 8, but the present disclosure is not limited to this configuration. A configuration may be adopted in which the gateway device 101 does not include the error counter 8, and the monitoring unit 2 acquires the count value CN of an error counter included in an in-vehicle device 202 or the like.

Also, the error counter is not limited to a configuration that indicates the number of occurrences of an error in received frames and may be configured to indicate the number of times the gateway device 101 receives an error frame from an in-vehicle device 202 in the event of error occurrence in a received frame of the in-vehicle device 202, for example.

The various processing (functions) of the above-described embodiment is performed by processing circuitry including one or more processors. The processing circuitry may be constituted by an integrated circuit or the like in which the one or more processors, one or more memories, various analog circuits, and various digital circuits are combined. The one or more memories store programs (commands) for causing the one or more processors to execute the various processing described above. The one or more processors may execute the various processing described above according to programs read from the one or more memories, or may execute the various processing described above in accordance with logic circuitry designed in advance to execute the various processing described above. The processors may be various processors suitable for controlling a computer, such as a central processing unit (CPU), a graphics processing unit (GPU), a digital signal processor (DSP), a field programmable gate array (FPGA), and an application specific integrated circuit (ASIC). The plurality of processors which are physically separated may cooperate with each other to execute the various processing described above. For example, the processors installed in a plurality of computers that are physically separated may cooperate with each other via a network such as a local area network (LAN), a wide area network (WAN), or the Internet to execute the various processing described above. The programs may be installed in the memory from an external server device or the like via the network or may be distributed in a state of being stored in a recording medium such as a compact disc read only memory (CD-ROM), a digital versatile disk read only memory (DVD-ROM), or a semiconductor memory, and may be installed in the memory from the recording medium.

The above embodiments are illustrative examples in all aspects and should not be considered as restrictive. The scope of the present disclosure is defined not by the above descriptions but by the claims, and all changes that come within the meaning and range of equivalency of the claims are intended to be embraced therein.

The above description includes the following features.

### Supplementary Note 1

A monitoring device to be installed in a vehicle, including processing circuitry, wherein the processing circuitry monitors a count value of a counter that counts the number of occurrences of an error detected in an in-vehicle network of the vehicle, generates pattern information indicating temporal change in the count value, based on a result of the monitoring, and detects an abnormality in the in-vehicle network, based on the generated pattern information and reference information that is based on temporal change in the count value measured in advance.

1. A monitoring device to be installed in a vehicle, comprising:
a monitoring unit configured to monitor a count value of a counter that counts the number of occurrences of an error detected in an in-vehicle network of the vehicle;
a pattern information generation unit configured to generate pattern information indicating temporal change in the count value, based on a result of the monitoring by the monitoring unit; and
an abnormality detection unit configured to detect an abnormality in the in-vehicle network, based on the pattern information generated by the pattern information generation unit and reference information that is based on temporal change in the count value measured in advance.

2. The monitoring device according to claim 1,
wherein the reference information is pattern information indicating temporal change in the count value measured in advance, and
the abnormality detection unit compares the pattern information generated by the pattern information generation unit with the reference information and detects an abnormality in the in-vehicle network, based on a result of the comparison.

3. The monitoring device according to claim 2,
wherein the abnormality detection unit is capable of performing first abnormality detection processing for detecting the abnormality based on the pattern information generated by the pattern information generation unit and the reference information, and second abnormality detection processing for detecting the abnormality based on a result of comparison between the count value and a predetermined threshold value, and
a maximum value of the count value in the reference information is smaller than the predetermined threshold value.

4. The monitoring device according to claim 1, wherein the abnormality detection unit performs the first abnormality detection processing for detecting the abnormality based on the pattern information generated by the pattern information generation unit and the reference information in parallel with the second abnormality detection processing for detecting the abnormality based on the result of comparison between the count value and the predetermined threshold value.

5. The monitoring device according to claim 1, wherein the error is an error relating to communication in the in-vehicle network.

6. The monitoring device according to claim 5, wherein the error is an error caused by a cyclic redundancy check (CRC) conforming to controller area network (CAN) standards.

7. The monitoring device according to claim 2, wherein the abnormality detection unit detects the abnormality by performing the comparison using a statistical analysis technique.

8. The monitoring device according to claim 1,
wherein the reference information is a learning model created by machine learning using temporal change in the count value measured in advance, and
the abnormality detection unit detects an abnormality in the in-vehicle network by providing the pattern information generated by the pattern information generation unit to the learning model.

9. The monitoring device according to claim 1, further comprising an abnormality processing unit configured to perform predetermined notification processing when the abnormality detection unit detects the abnormality.

10. The monitoring device according to claim 1, further comprising an abnormality processing unit configured to perform stop control for stopping the monitoring device from receiving data from the in-vehicle network when the abnormality detection unit detects the abnormality.

11. The monitoring device according to claim 10, wherein the abnormality processing unit cancels the stop control after a predetermined time elapses from when the stop control is performed.

12. The monitoring device according to claim 11,
wherein the reference information is pattern information indicating temporal change in the count value measured in advance,
the abnormality detection unit compares the pattern information generated by the pattern information generation unit with the reference information and detects an abnormality in the in-vehicle network, based on a result of the comparison, and
the abnormality processing unit sets the predetermined time according to the result of the comparison.

13. A vehicle monitoring method in a monitoring device to be installed in a vehicle, the vehicle monitoring method comprising:
a step of monitoring a count value of a counter that counts the number of occurrences of an error detected in an in-vehicle network of the vehicle;
a step of generating pattern information indicating temporal change in the count value, based on a result of the monitoring; and
a step of detecting an abnormality in the in-vehicle network, based on the generated pattern information and reference information that is based on temporal change in the count value measured in advance.

14. A vehicle monitoring program for use in a monitoring device to be installed in a vehicle, the program causing a computer to function as:
a monitoring unit configured to monitor a count value of a counter that counts the number of occurrences of an error detected in an in-vehicle network of the vehicle;
a pattern information generation unit configured to generate pattern information indicating temporal change in the count value, based on a result of the monitoring by the monitoring unit; and
an abnormality detection unit configured to detect an abnormality in the in-vehicle network, based on the pattern information generated by the pattern information generation unit and reference information that is based on temporal change in the count value measured in advance.
